(19) United States
(12) Patent Application Publication
(10) Pub. No.: US 2026/0330091 A1
(43) Pub. Date: Oct. 22, 2026

(54) HIGH-ROBUSTNESS POWER GRID DESIGN METHOD BASED ON PARAMETER-ADJUSTABLE HETEROGENEOUS MODELING

(71) Applicant: Beihang University, Beijing (CN)

(72) Inventors: Qi WU, Beijing (CN); Xinyue ZHANG, Beijing (CN)

(73) Assignee: Beihang University, Beijing (CN)

(21) Appl. No.: 19/212,781

(22) Filed: May 20, 2025

(30) Foreign Application Priority Data
Apr. 17, 2025 (CN) 202510481539.1

(51) Int. Cl. G06F 30/20; G06F 113/04

(52) U.S. Cl. CPC G06F 30/20; G06F 2113/04

(57) ABSTRACT

The provided is a high-robustness power grid design method based on parameter-adjustable heterogeneous modeling. The method includes: constructing a network topology based on a small-world network; building a heterogeneous collaborative model; conducting asynchronous generator penetration rate optimization and admittance matrix reconstruction calculation; determining whether to adjust an asynchronous generator penetration rate; if so, returning to the asynchronous generator penetration rate optimization step; otherwise, conducting node betweenness centrality analysis; determining whether to adjust the asynchronous generator placement strategy; if so, returning to the asynchronous generator placement strategy adjustment step; otherwise, adjusting a synchronous generator coupling strength and adjusting asynchronous generator inertia parameters and damping coefficients; determining whether to adjust the coupling strength; if so, returning to the synchronous generator coupling strength adjustment step; otherwise, outputting a current asynchronous generator penetration rate, asynchronous generator node indices, a synchronous generator coupling strength, and asynchronous generator inertia parameters and damping coefficients.

### CROSS-REFERENCE TO THE RELATED APPLICATIONS

This application is based upon and claims priority to Chinese Patent Application No. 202510481539.1, filed on Apr. 17, 2025, the entire contents of which are incorporated herein by reference.

### TECHNICAL FIELD

The invention relates to the field of power grid design, in particular to a high-robustness power grid design method based on parameter-adjustable heterogeneous modeling.

### BACKGROUND

Global energy shortages and environmental issues have accelerated the transition of the global energy system towards low-carbon and clean energy. As a core area, the power system is undergoing profound changes. In this process, the power system is gradually shifting from a traditional synchronous generator-dominated model to one dominated by asynchronous generators (such as wind and photovoltaic power). The high proportion of new energy sources connected to the grid poses severe challenges to grid stability. Research shows that, under the context of a high proportion of asynchronous generator integration, the grid faces issues such as reduced inertia and frequency instability. Traditional grid control and stability analysis methods are no longer effective in this scenario. In particular, existing research often focuses on the analysis of synchronous generator nodes, using simplified first-order dynamic models to explore the overall behavior of the grid, while neglecting the significant impact of asynchronous generators on the dynamic characteristics of the grid. This oversight prevents an accurate depiction of the desynchronization mechanisms following the integration of high proportions of renewable energy. Therefore, it is crucial to develop a novel power grid design method that can accurately describe the interactions of different types of generators in a heterogeneous grid and possesses high robustness.

The heterogeneous grid refers to a power network composed of various types of electrical devices and generator units with different technological systems, including traditional synchronous generators, asynchronous generators such as wind and photovoltaic power, and energy storage systems. Due to the significant differences in dynamic response and stability characteristics among these devices, the design and optimization of heterogeneous grids face unprecedented challenges. Traditional grid analysis methods often lack sufficient parameter adjustability, making it difficult to flexibly adjust the integration ratios of various types of generator units, the spatial distribution of power generation nodes, and the coupling strength therebetween. Specifically, a parameter-adjustable design method should encompass the ability to regulate multiple factors, including the types of generator units, installed capacity, grid connection locations, and their coupling relationships, to achieve dynamic optimization and robustness enhancement of the grid. By flexibly controlling these parameters, it is possible to ensure stable operation of the grid under high proportions of renewable energy integration, even in the face of load fluctuations and system failures, thereby achieving greater system robustness and adaptability.

Therefore, a parameter-adjustable heterogeneous modeling method can serve as a core tool for the design and optimization of power grids. By comprehensively considering the dynamic responses of different types of electrical devices and flexibly adjusting key system parameters, this method enables dynamic optimization of the grid, ensuring that the power system can operate efficiently, stably, and reliably even under high proportions of renewable energy integration.

### SUMMARY

The invention aims to overcome the shortcomings of the prior art by providing a high-robustness power grid design method based on parameter-adjustable heterogeneous modeling. The method achieves closed-loop optimization of multidimensional control parameters, addressing the technical bottlenecks in heterogeneous power source coupling modeling and distributed control strategies found in traditional methods.

To achieve the above objective, the invention adopts the following technical scheme. The invention provides a high-robustness power grid design method based on parameter-adjustable heterogeneous modeling, comprising:
S1, constructing a network topology based on a small-world network;
S2, building a heterogeneous collaborative model based on the principle of energy conservation;
S3, conducting asynchronous generator penetration rate optimization and admittance matrix reconstruction calculation;
S4, calculating a maximum frequency deviation and convergence time under a current asynchronous generator penetration rate, and determining whether the maximum frequency deviation is less than
a set optimal frequency deviation threshold and whether the convergence time is less than a set optimal convergence threshold; if so, proceeding to S5; otherwise, returning to S3;
S5, conducting node betweenness centrality analysis and adjusting an asynchronous generator placement strategy based on the node betweenness centrality analysis;
S6, calculating a maximum frequency deviation and convergence time under a current placement strategy, and determining whether the maximum frequency deviation is less than
a set optimal frequency deviation threshold and whether the convergence time is less than a set optimal convergence threshold; if so, proceeding to S7; otherwise, returning to S5;
S7, incrementally adjusting a synchronous generator coupling strength using a specified first step size, and adjusting asynchronous generator inertia parameters and damping coefficients with a specified second step size;
S8, calculating a maximum frequency deviation and convergence time under a current synchronous generator coupling strength and current asynchronous generator inertia parameters and damping coefficients, and determining whether the maximum frequency deviation is less than a set optimal frequency deviation threshold and whether the convergence time is less than a set optimal convergence threshold; if so, proceeding to S9; otherwise, returning to S7; and
S9, outputting a current asynchronous generator penetration rate, asynchronous generator node indices, a synchronous generator coupling strength, and asynchronous generator inertia parameters and damping coefficients.

Further, S1 specifically comprises:
generating a node architecture with a specified number of nodes based on the small-world network, categorizing the nodes into synchronous generator nodes, asynchronous generator nodes, and load nodes, each represented by different shapes, the nodes being interconnected by straight lines, and setting the number of the generator nodes and the number of the load nodes.

Further, S2 specifically comprises:
building the heterogeneous collaborative model based on the principle of energy conservation, the heterogeneous collaborative model consisting of a second-order dynamic equation for synchronous generators and a virtual synchronous control equation for asynchronous generators;
second-order dynamic equation for synchronous generators:

$${M}_{i} {\ddot{θ}}_{i} + {D}_{i} {\dot{θ}}_{i} = {P}_{i} + {\sum }_{j = 1}^{N} {a}_{ij} sin ( {θ}_{j} - {θ}_{i} )$$

virtual synchronous control equation for asynchronous generators:

$${M}_{i} {\ddot{θ}}_{i} + {D}_{i} {\dot{θ}}_{i} = {P}_{N , i} - \vert {E}_{i} \vert {\sum }_{j = 1}^{N} \vert {E}_{j} \vert \vert {Y}_{ij} \vert sin ( {θ}_{i} - {θ}_{j} )$$

where θᵢ represents the output phase angle of an i^{th} generator node, Mᵢ is the damping coefficient, Dᵢ is the inertia coefficient, aᵢⱼ is the equivalent coupling coefficient, Pᵢ is the equivalent input power, Eᵢ is the equivalent voltage, and Yᵢⱼ is the node admittance matrix; and
applying the fourth-order Runge-Kutta method to find a solution, and outputting frequency deviation data for all nodes and a time required to stabilize after disturbance.

Further, S3 specifically comprises:
conducting the asynchronous generator penetration rate ρ optimization, with Nₑ being the number of asynchronous generator nodes in the network topology, and Nₙₑₜ being the total number of nodes in the network topology, then:

$$ρ = \frac{{N}_{e}}{{N}_{net}} ;$$

the penetration rate ρ being incrementally raised using a specified step size to facilitate the transition of a power system from a synchronous generator-dominated mode to one dominated by asynchronous generators.

Further, in S5,
σ(s,t) represents the total number of shortest paths from node s to node t, while σ(s,v,t) denotes the number of paths that include node v among the shortest paths from node s to node t, then the betweenness centrality for node v is defined as:

$$C ( v ) = {\sum }_{s \neq v \neq t} \frac{σ ( s , v , t )}{σ ( s , t )}$$

the placement strategy comprises: placing asynchronous generators at a minimum sum location of all asynchronous generator nodes C(v) and in response to a plurality of placement options, adjusting the placement strategy in ascending order of node indices.

The invention has the following beneficial effects.

The invention constructs a dynamic collaborative model with parameter reconfiguration capabilities, introducing both synchronous and asynchronous generators into a heterogeneous power grid system. The method determines and optimizes the initial layout of asynchronous generators based on node betweenness centrality, and implements regional autonomous parameter regulation and multi-scenario adaptive modeling of the power grid system. This approach achieves a synergistic enhancement of local stability and global robustness to address challenges such as reduced inertia and frequency instability faced by systems with a high proportion of renewable energy.

### BRIEF DESCRIPTION OF THE DRAWINGS

FIG. 1 is a flowchart of a high-robustness power grid design method based on parameter-adjustable heterogeneous modeling according to an embodiment of the invention;

FIG. 2 is a flowchart of the specific process for a power grid design method according to an embodiment of the invention; and

FIGS. 3A-3F show an example diagram illustrating the implementation effect of a 30-node power grid system designed according to an embodiment of the invention.

### DETAILED DESCRIPTION OF THE EMBODIMENTS

In order to make the objectives, technical schemes and advantages of the embodiments of the invention clearer, the technical schemes in the embodiments of the invention are clearly and completely described below with reference to the accompanying drawings in the embodiments of the invention.

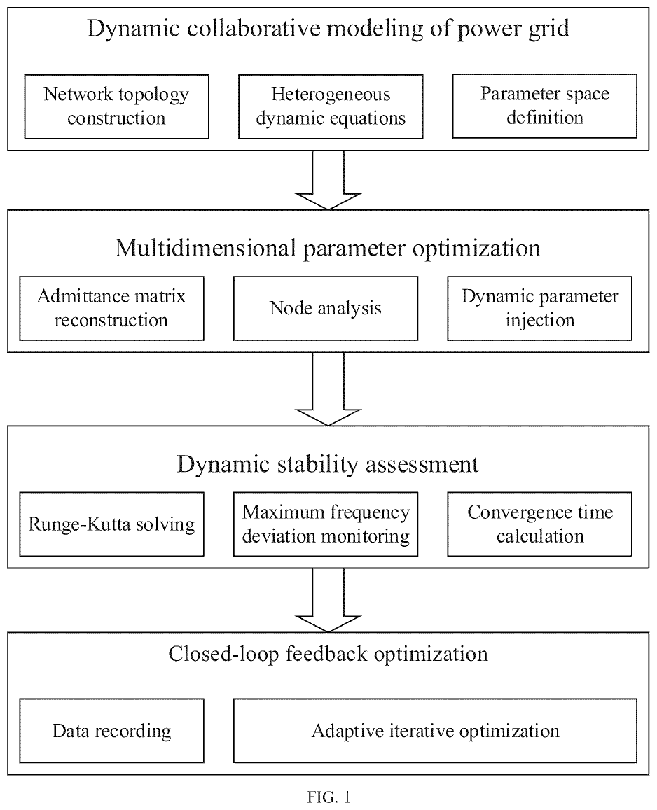

As shown in FIG. 1, the invention provides a high-robustness power grid design method based on parameter-adjustable heterogeneous modeling, which comprises the following stages: a dynamic collaborative modeling stage, involving the construction of a complex network topology, the establishment of heterogeneous dynamic equations, and the definition of a three-dimensional parameter space; a multidimensional parameter optimization stage, involving the introduction of an admittance matrix reconstruction algorithm, node betweenness centrality analysis, and dynamic parameter injection; a dynamic stability assessment stage, involving the utilization of the fourth-order Runge-Kutta method to find a solution and dual-metric stability criterion analysis; and a closed-loop feedback optimization stage, involving real-time data recording and adaptive iterative optimization.

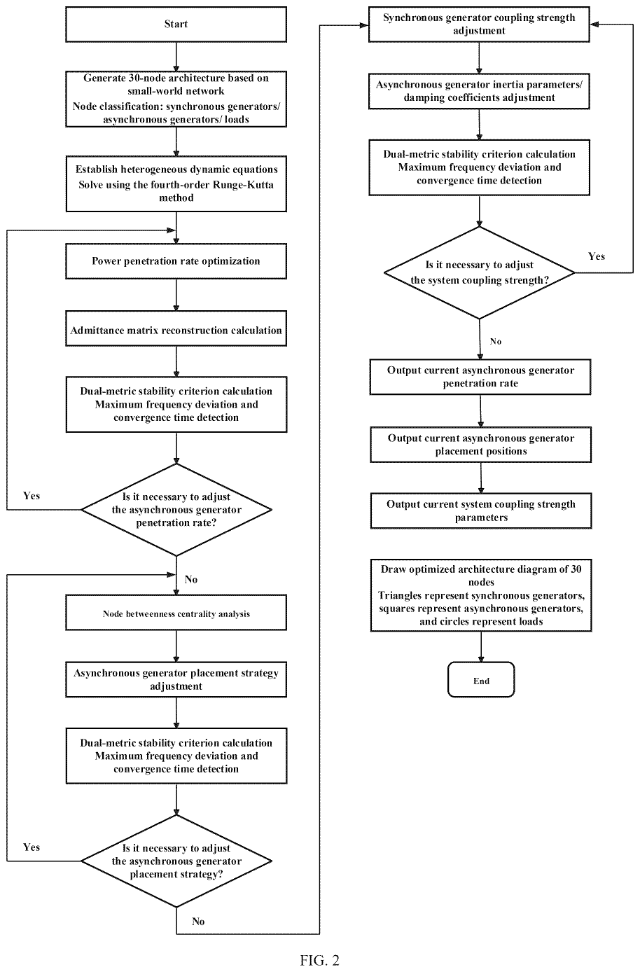

As shown in FIG. 2, the high-robustness power grid design method based on parameter-adjustable heterogeneous modeling specifically comprises the following steps.
S1, generating a node architecture with a specified number of nodes based on the small-world network, categorizing the nodes into synchronous generator nodes, asynchronous generator nodes, and load nodes, each represented by different shapes, such as squares, triangles, and circles, the nodes being interconnected by straight lines, and setting the number of the generator nodes and the number of the load nodes.
S2, establishing a set of heterogeneous dynamic equations and solving them using the fourth-order Runge-Kutta method; for dynamic collaborative modeling of the power grid, forming a heterogeneous collaborative model by a second-order dynamic equation for synchronous generators (1) and a virtual synchronous control equation for asynchronous generators (2) constructed based on the principle of energy conservation:

$${M}_{i} {\ddot{θ}}_{i} + {D}_{i} {\dot{θ}}_{i} = {P}_{i} + {\sum }_{j = 1}^{N} {a}_{ij} sin ( {θ}_{j} - {θ}_{i} ) ; \qquad ( 1 )$$

$${M}_{i} {\ddot{θ}}_{i} + {D}_{i} {\dot{θ}}_{i} = {P}_{N , i} - \vert {E}_{i} \vert {\sum }_{j = 1}^{N} \vert {E}_{j} \vert \vert {Y}_{ij} \vert sin ( {θ}_{i} - {θ}_{j} ) ; \qquad ( 2 )$$

where θᵢ represents the output phase angle of an i^{th} generator node, Mᵢ is the damping coefficient, Dᵢ is the inertia coefficient, aᵢⱼ is the equivalent coupling coefficient, Pᵢ is the equivalent input power, Eᵢ is the equivalent voltage, and Yᵢⱼ is the node admittance matrix; and
applying the fourth-order Runge-Kutta method to find a solution, and outputting frequency deviation data for all nodes and a time required to stabilize after disturbance, followed by further visualization processing.
S3, conducting the asynchronous generator penetration rate ρ optimization, with Nₑ being the number of asynchronous generator nodes in the network system, and Nₙₑₜ being the total number of nodes in the network system, then:

$$ρ = \frac{{N}_{e}}{{N}_{net}} ;$$

the penetration rate ρ being incrementally raised with a step size of 10% to facilitate the transition of a power system from a traditional synchronous generator-dominated mode to one dominated by asynchronous generators (such as wind and photovoltaic power).
S4, conducting admittance matrix reconstruction calculation. In S3, increasing the number of connected asynchronous generators leads to an expansion of the admittance matrix. This step introduces the admittance matrix reconstruction calculation, utilizing the characteristic of zero bus current injection to eliminate redundant nodes and merge their effects into the remaining network, thereby simplifying the complete interconnection among all generator nodes.
S5, calculating a dual-metric stability criterion under the current conditions. The dual-metric stability criterion consists of two parts: transient constraint and dynamic constraint. The transient constraint is defined as the maximum frequency deviation Δθ_{MAX}. Specifically, after the system network experiences a disturbance, the maximum value Δθ_{MAX}<4.0 among all node frequency deviations Δθᵢ is defined as the optimal design scheme. The dynamic constraint is convergence time Tₛ, specifically the maximum value among the time Tᵢ required for all node frequency deviations to return to zero after the network is disturbed. The convergence time Tₛ<50 s is defined as the optimal design scheme. Therefore, the dual-metric stability criterion is defined as follows: a solution is considered optimal if it meets both conditions: a maximum frequency deviation of less than 4.0 and a convergence time of less than 50 seconds. This approach overcomes the limitations of a single criterion.
S6, determining whether to adjust the asynchronous generator penetration rate ρ, the criterion for this decision being the dual-metric stability criterion under the current conditions from S5; if adjustment is needed, returning to S3; otherwise, proceeding to S7.
S7, conducting node betweenness centrality analysis. σ(s,t) represents the total number of shortest paths from node s to node t, while σ(s,v,t) denotes the number of paths that include node v among the shortest paths from node s to node t, then the betweenness centrality for node v is defined as:

$$C ( v ) = {\sum }_{s \neq v \neq t} \frac{σ ( s , v , t )}{σ ( s , t )} ;$$

a node with high betweenness centrality indicates that it is essential for the flow of information or resources; therefore, in the design of the invention, it is advisable to avoid placing asynchronous generators near nodes with high betweenness centrality
S8, adjusting an asynchronous generator placement strategy, specifically, placing asynchronous generators at a minimum sum location of all asynchronous generator nodes C(v), and in response to a plurality of placement options, adjusting the placement strategy in ascending order of node indices.
S9, calculating a dual-metric stability criterion under the current conditions; based on the criterion, determining whether to adjust the asynchronous generator placement strategy; if adjustment is needed, returning to S7; otherwise, proceeding to S10.
S10, adjusting a synchronous generator coupling strength K. For synchronous generators, a greater K improves system stability, but it also increases the required investment cost. Specifically, start with an initial value of 5 and incrementally adjust the synchronous generator coupling strength K with a step size of 0.5.
S11, adjusting asynchronous generator inertia parameters M and damping coefficients D. For asynchronous generators, the smaller the ratio of the inertia parameter M to the damping coefficient D, the better the system stability; however, this also leads to higher required investment cost. Specifically, start with an initial value of M/D=1 and gradually reduce the asynchronous generator inertia parameters M and damping coefficients D with a step size of 0.1.
S12, calculating a dual-metric stability criterion under the current conditions; based on the criterion, determining whether to adjust a system coupling strength, if adjustment is needed, returning to S10; otherwise, proceeding to S13.
S13, outputting a current asynchronous generator penetration rate ρ.
S14, outputting current asynchronous generator placement positions. Specifically, the output content is the node indices of the asynchronous generators.
S15, outputting current coupling system strength parameters. Specifically, the output content is the synchronous generator coupling strength K, as well as the asynchronous generator inertia parameters M and damping coefficients D.
S16, drawing an optimized architecture diagram of 30 nodes, where squares represent synchronous generator nodes, triangles represent asynchronous generator nodes, and circles represent load nodes.

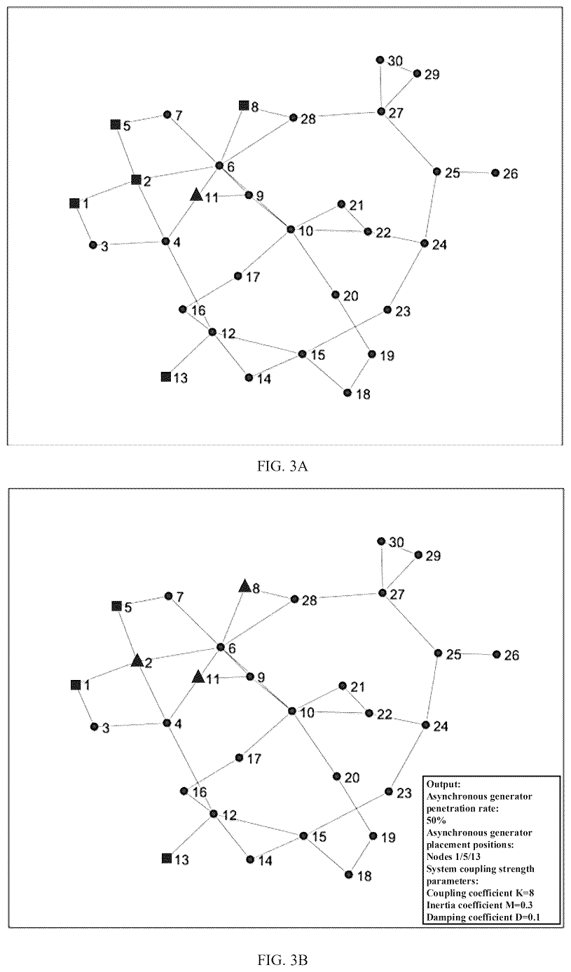

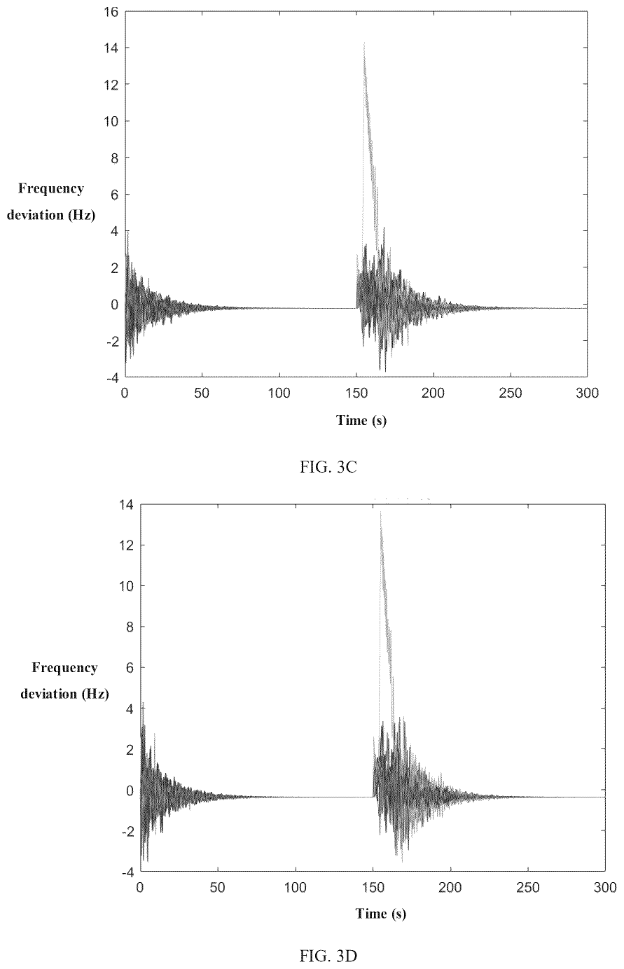

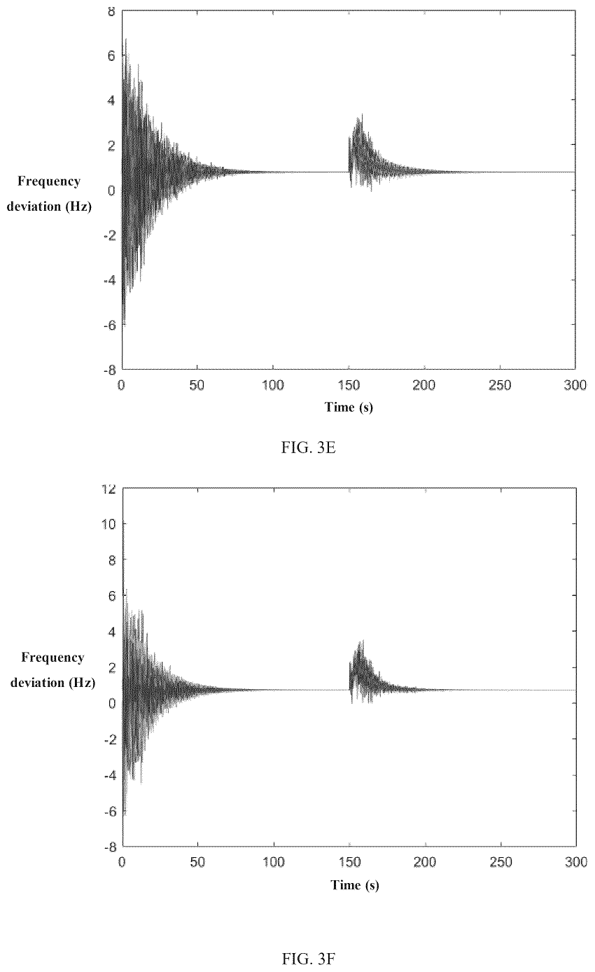

FIGS. 3A-3F illustrate a 30-node system implementation example based on this design method. FIG. 3A displays the initial network topology setup; specifically, the asynchronous generator penetration rate ρ=80%, the asynchronous generators are placed at nodes 1, 2, 5, 8, and 13, the synchronous generator coupling strength K=5, and the ratio of the inertia parameter M to the damping coefficient D of the asynchronous generators is 1. The visualization of the dual-metric stability criterion for the initial system is illustrated in FIG. 3C.

During the iterative steps S3-S6, with other parameters held constant, the asynchronous generator penetration rate is optimized to ρ=50%. The visualization of the dual-metric stability criterion is shown in FIG. 3D. Specifically, the maximum frequency deviation Δθ_{MAX} is reduced by 2, and the convergence time Ly is decreased by 10 seconds.

During the iterative steps S7-S10, with other parameters held constant, the asynchronous generators are placed at nodes 1, 5, and 13. The visualization of the dual-metric stability criterion is shown in FIG. 3E. Specifically, the maximum frequency deviation Δθ_{MAX} is reduced by 8, and the convergence time Is is decreased by 20 seconds.

During the iterative steps S11-S13, with other parameters held constant, the synchronous generator coupling strength K=8 is optimized, and the ratio of the inertia parameter M to the damping coefficient D of the asynchronous generators is 0.3. The visualization of the dual-metric stability criterion is shown in FIG. 3F. Specifically, the maximum frequency deviation Δθ_{MAX} is reduced by 1(<4), and the convergence time Tₛ is decreased by 10 seconds (<50 seconds). The optimal design solution is output.

In summary, the invention introduces both synchronous and asynchronous generators into a heterogeneous power grid system through a set of second-order dynamic equations. The method determines and optimizes the initial layout of asynchronous generators based on node betweenness centrality, and implements regional autonomous parameter regulation and multi-scenario adaptive modeling of the power grid system. This approach achieves a synergistic enhancement of local stability and global robustness to address challenges such as reduced inertia and frequency instability faced by systems with a high proportion of renewable energy.

The above are only preferred embodiments of the invention. It should be understood that the invention is not limited to the forms disclosed herein, should not be regarded as excluding other embodiments, but can be used in various other combinations, modifications and improvements, and can be modified by the above teaching or the technology or knowledge in related fields within the scope of the inventive concept described herein. The modifications and changes made by those skilled in the art without departing from the spirit and scope of the invention should be within the scope of protection of the appended claims.

1. A high-robustness power grid design method based on parameter-adjustable heterogeneous modeling, comprising:
S1, constructing a network topology based on a small-world network;
S2, building a heterogeneous collaborative model based on a principle of energy conservation;
S3, conducting asynchronous generator penetration rate optimization and admittance matrix reconstruction calculation;
S4, calculating a first maximum frequency deviation and first convergence time under a current asynchronous generator penetration rate, and determining whether the first maximum frequency deviation is less than a first set optimal frequency deviation threshold and whether the first convergence time is less than a first set optimal convergence threshold; when the first maximum frequency deviation is less than the first set optimal frequency deviation threshold and the first convergence time is less than the first set optimal convergence threshold, proceeding to S5; when the first maximum frequency deviation is greater than or equal to the first set optimal frequency deviation threshold and the first convergence time is greater than or equal to the first set optimal convergence threshold, returning to S3;
S5, conducting node betweenness centrality analysis and adjusting an asynchronous generator placement strategy based on the node betweenness centrality analysis;
S6, calculating a second maximum frequency deviation and second convergence time under a current placement strategy, and determining whether the second maximum frequency deviation is less than a second set optimal frequency deviation threshold and whether the second convergence time is less than a second set optimal convergence threshold, when the second maximum frequency deviation is less than the second set optimal frequency deviation threshold and the second convergence time is less than the second set optimal convergence threshold, proceeding to S7, when the second maximum frequency deviation is greater than or equal to the second set optimal frequency deviation threshold and the second convergence time is greater than or equal to the second set optimal convergence threshold, returning to S5;
S7, incrementally adjusting a synchronous generator coupling strength using a predetermined first step size, and adjusting asynchronous generator inertia parameters and damping coefficients with a predetermined second step size;
S8, calculating a third maximum frequency deviation and third convergence time under a current synchronous generator coupling strength and current asynchronous generator inertia parameters and damping coefficients, and determining whether the third maximum frequency deviation is less than a third set optimal frequency deviation threshold and whether the third convergence time is less than a third set optimal convergence threshold; when the third maximum frequency deviation is less than the third set optimal frequency deviation threshold and the third convergence time is less than the third set optimal convergence threshold, proceeding to S9; when the third maximum frequency deviation is greater than or equal to the third set optimal frequency deviation threshold and the third convergence time is greater than or equal to the third set optimal convergence threshold, returning to S7; and
S9, outputting a current asynchronous generator penetration rate, asynchronous generator node indices, a synchronous generator coupling strength, and asynchronous generator inertia parameters and damping coefficients.

2. The high-robustness power grid design method based on the parameter-adjustable heterogeneous modeling according to claim 1, wherein S1 comprises:
generating a node architecture with a predetermined number of nodes based on the small-world network, categorizing the nodes into synchronous generator nodes, asynchronous generator nodes, and load nodes, each represented by different shapes, the nodes being interconnected by straight lines, and setting the number of the synchronous and asynchronous generator nodes and the number of the load nodes.

3. The high-robustness power grid design method based on the parameter-adjustable heterogeneous modeling according to claim 1, wherein S2 comprises:
building the heterogeneous collaborative model based on the principle of energy conservation, the heterogeneous collaborative model consisting of a second-order dynamic equation for synchronous generators and a virtual synchronous control equation for asynchronous generators;
the second-order dynamic equation for synchronous generators:
$${M}_{i} {\ddot{θ}}_{i} + {D}_{i} {\dot{θ}}_{i} = {P}_{i} + {\sum }_{j = 1}^{N} {a}_{ij} sin ( {θ}_{j} - {θ}_{i} )$$
the virtual synchronous control equation for asynchronous generators:
$${M}_{i} {\ddot{θ}}_{i} + {D}_{i} {\dot{θ}}_{i} = {P}_{N , i} - \vert {E}_{i} \vert {\sum }_{j = 1}^{N} \vert {E}_{j} \vert \vert {Y}_{ij} \vert sin ( {θ}_{i} - {θ}_{j} )$$
where θᵢ represents an output phase angle of an i^{th} generator node, Mᵢ is the damping coefficient, Dᵢ is an inertia coefficient, aᵢⱼ is an equivalent coupling coefficient, Pᵢ is an equivalent input power, Eᵢ is an equivalent voltage, and Yᵢⱼ is a node admittance matrix.

4. The high-robustness power grid design method based on the parameter-adjustable heterogeneous modeling according to claim 1, wherein S3 comprises:
conducting asynchronous generator penetration rate ρ optimization, with Nₑ being the number of the asynchronous generator nodes in the network topology, and Nₙₑₜ being a total number of nodes in the network topology, and:
$$ρ = \frac{{N}_{e}}{{N}_{net}} ;$$
the asynchronous generator penetration rate ρ being incrementally raised using a predetermined step size to facilitate a transition of a power system from a synchronous generator-dominated mode to one dominated by asynchronous generators.

5. The high-robustness power grid design method based on the parameter-adjustable heterogeneous modeling according to claim 1, wherein in S5,
σ(s,t) represents a total number of shortest paths from node s to node t, while σ(s,v,t) denotes the number of paths that comprise node v among the shortest paths from node s to node t, and a betweenness centrality for node v is defined as:
$$C ( v ) = {\sum }_{s \neq v \neq t} \frac{σ ( s , v , t )}{σ ( s , t )}$$
the placement strategy comprises: placing asynchronous generators at a minimum sum location of all asynchronous generator nodes C(v), and in response to a plurality of placement options, adjusting the placement strategy in ascending order of node indices.
